(19) United States
(12) Patent Application Publication
(10) Pub. No.: US 2010/0224100 A1
(43) Pub. Date: Sep. 9, 2010

(54) THREE-DIMENSIONAL PAINT COMPOSITION

(75) Inventor: Michael S. Craig, Sciota, PA (US)

Correspondence Address: RATNERPRESTIA, P.O. BOX 980, VALLEY FORGE, PA, 19482, US

(73) Assignee: Crayola LLC, Easton, PA (US)

(21) Appl. No.: 12/399,132

(22) Filed: Mar. 6, 2009

(51) Int. Cl. C09D 133/08; C09D 5/14

(52) U.S. Cl. 106/287.25; 524/197

(57) ABSTRACT

Three-dimensional paint compositions comprise a urethane dispersion and a thickener present in effective amounts to allow the composition to retain three-dimensional stability. The three-dimensional paint compositions are phthalate-free. A system also provides a dispenser or applicator for applying the three-dimensional paint compositions. The three-dimensional paint compositions are preferably toy products intended primarily for use by parents, teachers, and children. Methods for making three-dimensional paint compositions include combining a urethane dispersion and a thickener to form a mixture, and alternatively adding, for example, a coloring agent, preservative, biocide, or combinations thereof.

### FIELD OF THE INVENTION

The present invention relates to three-dimensional paint compositions, and more particularly to three-dimensional paint compositions for use as toy products.

### BACKGROUND OF THE INVENTION

There are many paint products that are directed to children. A vast majority of children's paints are used for creating two-dimensional works of art when applied to a surface. Paints that are considered to be “two-dimensional” have varying levels of consistency and thickness. However, as measured from the surfaces to which they are applied, two-dimensional paints generally have a negligible height, or essentially no height at all. It is therefore desirable to provide paints which allow for added elements of creativity by enabling users to make “three-dimensional paintings” which can be. built up to substantial heights and manipulated into desired shapes.

Furthermore, it is desirable for a children's paint product to be free of phthalates. Phthalates are a family of chemical compounds which are commonly added to a variety of consumer products, including paints and other children's products. Scientists and environmental groups have begun calling attention to possible health hazards posed by phthalates, such as reproductive defects and cancer. These scientific studies have raised enough concern about phthalates that several countries have banned or restricted the use of phthalates in toys, and many states in the U.S. are pushing for similar restrictions. In response, there has been pressure from consumers to move away from phthalates. Accordingly, it is desirable for children's paint products to be free of phthalates.

### SUMMARY OF THE INVENTION

The present invention provides three-dimensional paint compositions. A three-dimensional paint composition according to the present invention comprises a urethane dispersion and a thickener. The urethane dispersion and thickener are present in effective amounts to allow the composition to retain three-dimensional stability. The three-dimensional paint compositions are phthalate-free. A system according to the present invention provides a dispenser or applicator for applying the three-dimensional paint compositions. An exemplary embodiment of the invention is intended primarily for use as a toy product by parents, teachers, and children.

Methods for making three-dimensional paint compositions are also provided. A method according to the present invention comprises combining a urethane dispersion and a thickener to form a mixture, wherein the composition retains its three-dimensional stability upon drying. Alternative embodiments of this method further comprise adding, for example, a coloring agent, preservative, biocide, or combinations thereof.

It is to be understood that both the foregoing general description and the following detailed description are exemplary, but not restrictive, of the invention.

### BRIEF DESCRIPTION OF THE FIGURES

The features of the invention believed to be novel and the elements characteristic of the invention are set forth with particularity in the appended claims. The figures comprise photographs and are for illustration purposes only. The invention itself, however, may best be understood by reference to the detailed description which follows taken in conjunction with the accompanying figures in which:

FIG. 1 shows embodiments of the present invention having varying percentages of thickener;

FIG. 2a shows layered embodiments of the present invention having varying percentages of thickener;

FIG. 2b shows a layered application of “Elmer's 3D paint”; and

FIG. 3 shows a layered application of “Elmer's 3D paint” and a layered embodiment of the present invention, 24 hours after each initial application.

### DETAILED DESCRIPTION OF THE INVENTION

The present invention is generally directed to three-dimensional (“3D”) paint compositions. It includes a system for dispensing the 3D paint compositions and a method for making the 3D paint compositions. In particular, the present invention is directed to 3D paint compositions for use as toy products. Unlike conventional paints, the paint compositions of the present invention have low flowability, i.e. high viscosity, and are adapted to have three-dimensional qualities when applied to a surface. As used throughout, the term “three-dimensional” (or “3D”) refers to a composition having a noticeable height, as measured from a surface to which the composition is applied, which exceeds that of a thin film or conventional paint which, although has a thickness, is viewed to be essentially two-dimensional. The 3D compositions described herein can be manipulated into desired shapes, and can be built up to desired heights, such as by applying the compositions in layers. Once the composition is applied or dispensed to create a desired shape or mold, the composition hardens and becomes solid after a relatively short time period. In addition, alternative embodiments of the 3D paint compositions may vary in color, thus allowing a user to create multi-colored 3D “paintings” or artwork.

The 3D paint compositions of the present invention are free of phthalates. It has been stated by some scientists and environmental groups that phthalates possibly pose health hazards to adults and children. In response, consumers have expressed concern over the safety of phthalates, and many states in the U.S. are pushing for restrictions on the use of phthalates in toys. Thus, without being bound to any theory, it is possible that a lack of phthalates in the present invention provides an added element of safety and would also alleviate certain consumer concerns.

The 3D paint compositions of the present invention comprise a urethane dispersion and a thickener. The urethane dispersion and thickener are present in effective amounts to allow the paint composition to retain three-dimensional stability over time. The urethane dispersion may comprise both acrylic and urethane, or may comprise 100% urethane. A system according to the present invention further includes an applicator or dispenser for applying or dispensing the 3D paint composition. An applicator or dispenser may comprise, for example, a spatula, syringe, or tubular dispenser. As used herein, “to retain three-dimensional stability over time” refers to the ability of the paint composition to retain 3D stability, such as, for example, stability of height and shape, from the time that it is applied or dispensed onto a surface to the time that it dries or cures. The paint is considered to be dried or cured when it is dry and substantially rigid to the touch. The ability of the paint composition to retain 3D stability permits a user to create 3D paintings or artwork, such as by applying the composition in layers to create a desired shape or mold.

In a preferred embodiment, the urethane dispersion is water-based and comprises about 0% to 15% by weight acrylic and about 85% to 100% by weight urethane. Most preferably, the urethane dispersion comprises about 15% by weight acrylic and about 85% by weight urethane. In an exemplary embodiment, the urethane dispersion comprises Sancure® 20025F from The Lubrizol Corporation.

In a preferred embodiment, the thickener comprises a high molecular weight homo- and co-polymer of acrylic acid cross-linked with a polyalkenyl polyether. The thickener is present in an amount of about 1% to 4% by weight of the composition, and most preferably about 2.5% by weight of the composition. In an exemplary embodiment, the thickener comprises liquid Carbopol® EP-1 from The Lubrizol Corporation.

Alternative embodiments of the present invention include at least one coloring agent, such as a dye, so that the 3D paint compositions may vary in color, as mentioned above. The composition is preferably washable from fabric and skin. In addition, alternative embodiments may include at least one preservative, at least one biocide, at least one surfactant and/or defoamer (to help eliminate air bubbles from the composition), or combinations thereof.

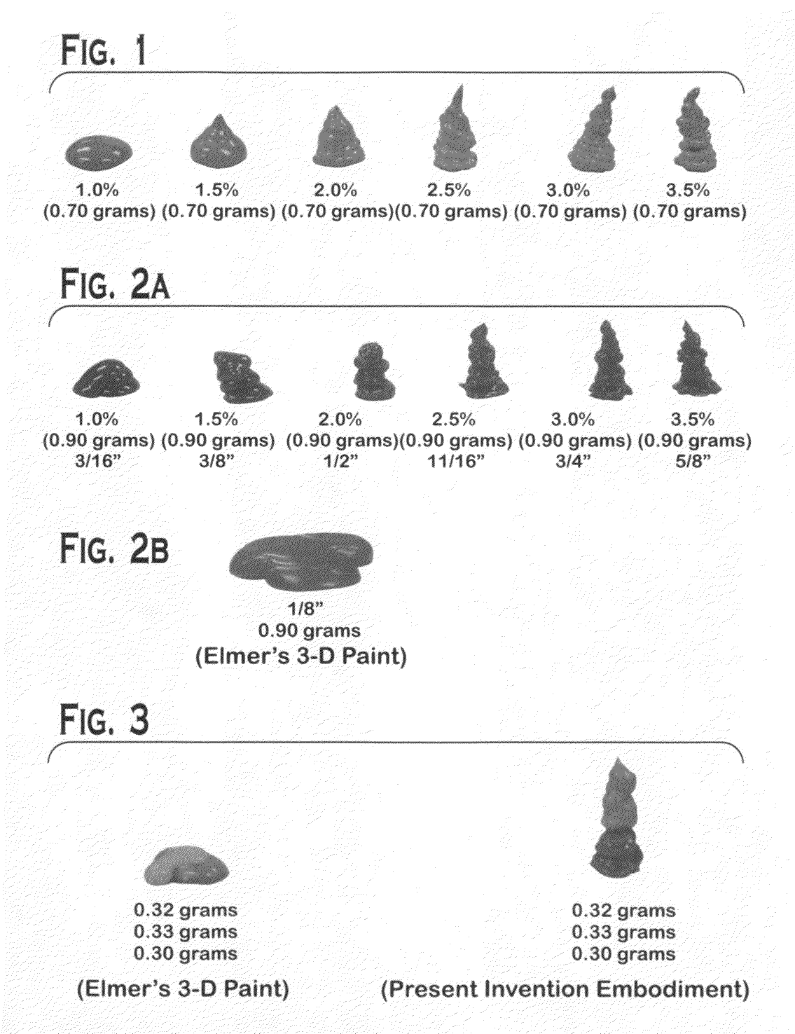

FIG. 1 shows a side-by-side comparison of six applications of the present invention. For each of the six applications shown in FIG. 1, 0.70 grams of the composition were applied to the surface with a dispenser and subsequently allowed to dry. Each of the six applications had a different percentage of thickener: from left to right, each application had 1.0%, 1.5%, 2.0%, 2.5%, 3.0%, and 3.5%, respectively, of Carbopol® EP-1. As shown in FIG. 1, the compositions having higher weight percentages of thickener (e.g. 2.5%, 3.0%, and 3.5%) retained more height when they dried, in comparison with compositions having lower weight percentages of thickener (e.g. 1.0%, 1.5%, and 2.0%). As the percentage of thickener in a 3D paint composition increases, the flowability of the composition generally decreases. Thus, as illustrated by FIG. 1, 3D paint compositions with higher weight percentages of thickener are better able to retain their height when they dry, as compared to 3D paint compositions with relatively lower weight percentages of thickener. However, due to their lower flowability, compositions having higher percentages of thickener may be more difficult to apply or dispense, depending on the type of applicator or dispenser used.

One product, sold by Elmer's Products, Inc. as “Elmer's 3D Paint,” is proposed to dry “raised,” and make the user's artwork, “pop.” The product, however, once applied, sags fairly substantially and dries with only a small amount of volume above the surface or substrate to which it is applied. Comparative examples have been provided to compare the alleged “3D Paint” of Elmer's with the current invention. FIGS. 2a and 2b, for example, illustrate the superior build-upon capability of the present invention in comparison to the Elmer's product, i.e. the ability of the 3D composition to retain its height when it dries, and to continue to retain its height after additional layers are added and subsequently allowed to dry.

FIG. 2a shows a side-by-side comparison of six layered applications of the present invention. For each of the six “towers” shown in FIG. 2a, a dispenser was used to make three separate applications of the composition layered on top of one another. A first application of 0.30 grams was applied to the surface. Two hours after the first application, a second application of 0.30 grams was added on top of the first application. Two hours after the second application, a third application of 0.30 grams was added on top of the second application, for a final total of 0.90 grams. As shown in FIG. 2a, each of the six 0.90 g “towers” had a different weight percentage of thickener: from left to right, each application had 1.0%, 1.5%, 2.0%, 2.5%, 3.0%, and 3.5%, respectively, of Carbopol® EP-1. Following the third application, the height of each tower was measured in inches, as shown in FIG. 2a : from left to right, the towers had approximate heights of 3/16 inch, ⅜ inch, ½ inch, 11/16 inch, ¾ inch, and ⅝ inch, respectively.

FIG. 2b shows 0.90 grams of “Elmer's 3D paint,” which was added to the same surface as the 3D paint compositions shown in FIG. 2a. The Elmer's product was applied in the same manner as the 3D paint compositions shown in FIG. 2a, namely, by three separate applications of 0.30 grams each layered on top of one another, with two hours between each application. The final height of the 0.90 grams of Elmer's product, as shown in FIG. 2b, was approximately ⅛ inch. Thus, after three layers of application, the height of the Elmer's product was lower than each of the 3D paint compositions of the present invention having varying percentages of thickener (e.g. the Elmer's product had a lower height than the composition of the present invention having 1.0% thickener). This illustrates the superior ability of the present invention, in comparison with the Elmer's product, to permit separate layers of the composition to be added on top of each other without sagging or losing a noticeable amount of height.

FIG. 3 shows a side-by-side comparison of the Elmer's product to a 3D paint composition of the present invention having 2.5% Carbopol® EP-1. In FIG. 3, similar to FIGS. 2a and 2b, there were three layered applications of each “3D paint,” namely, a first application of 0.32 grams; a second application of 0.33 grams two hours after the first application; and a third application of 0.30 grams two hours after the second application, for a total of 0.95 grams. FIG. 3 shows the layered applications after 24 hours lapsed from the time of the first application, long after each layered application had dried. As illustrated in FIG. 3, after 24 hours from the first application, the layered composition of the present invention had a significantly larger height than the layered application of the Elmer's product. Thus, FIG. 3 illustrates that the present composition also has an enhanced ability, when compared to the Elmer's product, in retaining its shape and height over time after it has dried.

Table 1 shows approximate viscosities and pH values of the Elmer's product and the present invention. The compositions of the present invention shown in Table 1 have varying percentages of Carbopol® EP-1. The measurements were taken with a Brookfield DV-1 Prime Digital Viscometer with a preferred torque percentage of about 20-80%. As shown in table 1, viscosity values for the present invention ranged from about 7,100 cps to 125,000 cps for weight percentages of Carbopol® EP-1 ranging from about 1.0% to 3.5%, respectively.

TABLE 1

| | | Viscosity in cps | | |
|---|---|---|---|---|
| Carbopol EP-1% | pH | @ 20 RPM's & % Torque | | Spindle # Used |
| 1.00 | 6.98 | 7,100 | cps @ 35.5% | 5 |
| 1.50 | 6.77 | 16,250 | cps @ 32.5% | 6 |
| 2.00 | 6.70 | 27,000 | cps @ 54% | 6 |
| 2.50 | 6.66 | 42,800 | cps @ 21.4% | 7 |
| 3.00 | 6.41 | 61,400 | cps @ 30% | 7 |
| 3.50 | 6.33 | 125,000 | cps @ 63.6% | 7 |
| Elmer's | 4.49 | 13,150 | @ 26.3% | 6 |

### EXAMPLES

Exemplary three-dimensional paint compositions according to the present invention were prepared according to the procedures set forth in the following examples and tables.

### Example 1

In order to prepare an exemplary three-dimensional paint having a white color (or absence of color), the first step included pouring one hundred grams of Sancure® 20025F urethane dispersion into a 250 ml beaker. In the second step, the Sancure® 20025F in the beaker was mixed using a Dispermat® CV laboratory dissolver (Dispermat® CV, VMA—Getzmann GMBH, Germany) within a range of about 8,000-10,000 RPMs. In the third step, 1.30 grams of Carbopol® EP-1 thickener was slowly added to the mixture in the beaker. As the mixture in the beaker started to adhere to the dissolver's mixing rod, the speed of the dissolver was increased. In the fourth step, three drops of Kathlon LX® 1.5% biocide (sold by Rohm and Haas), which amounted to about 0.10 grams, was added to the mixture. In the fifth step, six drops of the preservative, Nuosept® 95, which amounted to about 0.30 grams, was added to the mixture in the beaker. The solution further mixed for about two to three minutes. For the 3D paint composition according to Example 1, the components and their respective amounts and weight percentages are listed in Table 2. It is contemplated that Nuosept® 95 can be replaced with Reputaine® B-30. It is also contemplated that the weight percentage of Kathlon LX® 1.5% biocide can be lowered to 0.0775% with the difference in weight being added to the Sancure® 20025F. The substitution of Reputaine® B-30 and the lower percentage (0.0775%) of Kathlon LX® 1.5% biocide may help the composition comply with regulatory standards in certain countries.

TABLE 2
White

| Component | Amt. in Grams | Wt. % |
|---|---|---|
| Sancure 20025F | 100.00 | 98.33 |
| Carbopol EP-1 | 1.30 | 1.28 |
| 0.1% Kathon LX 1.5% (3 drops) | 0.10 | 0.10 |
| 0.3% Reputaine B-30 (6 drops) | 0.30 | 0.29 |
| | 101.70 | 100.00 |

### Example 2

Exemplary colored three-dimensional paints were prepared according to the procedure as set forth in Example 1, with an additional step, or steps, of adding at least one coloring agent. For producing the exemplary colored three-dimensional paints as listed in Table 3, the coloring agents in their respective predetermined amounts were added to the beaker containing Sancure® 20025F urethane dispersion of Example 1, prior to the step of adding the Carbopol® EP-1 thickener. In this step, a predetermined amount of a coloring agent, labeled as “Color” in Table 3 for each of the exemplary colors, was added to the mixture in the order listed. After the addition of at least one coloring agent, the resulting mixture was mixed for about two to three minutes before the addition of the Carbopol® EP-1 thickener.

For those paint compositions for which both liquid and solid particle dyes were added, the liquid dye was added first to the beaker containing the Sancure® 20025F urethane dispersion and allowed to mix for about two to three minutes before the addition of the solid particle coloring agent. After the addition of the solid particle coloring agent, the mixture was allowed to mix for about two to three minutes before the addition of the Carbopol® EP-1 thickener.

After at least one coloring agent was added to the mixture, the remaining steps as set forth in Example 1 were carried out to produce a 3D paint composition according to the present invention.

TABLE 3

| | | |
|---|---|---|
| Component | Amt. in Grams | Wt. % |

Blue

| | | |
|---|---|---|
| Sancure 20025F | 100.00 | 97.28 |
| Color - Milliken Blue Concentrated Ink (30 drops) | 1.10 | 1.07 |
| Carbopol EP-1 | 1.30 | 1.26 |
| 0.1% Kathon LX 1.5% (3 drops) | 0.10 | 0.10 |
| 0.3% Reputaine B-30 (6 drops) | 0.30 | 0.29 |
| | 102.80 | 100.00 |

Medium Blue

| | | |
|---|---|---|
| Sancure 20025F | 100.00 | 97.99 |
| Color - Milliken Blue Concentrated Ink (10 drops) | 0.35 | 0.34 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| Medium Blue | 102.05 | 100.00 |

Teal

| | | |
|---|---|---|
| Sancure 20025F | 100.00 | 92.85 |
| Color - Engelhard Mearlin Card Silver BN001 | 6.00 | 5.57 |
| Carbopol EP-1 | 1.30 | 1.21 |
| 0.1% Kathon LX 1.5% (3 drops) | 0.10 | 0.09 |
| 0.3% Reputaine B-30 (6 drops) | 0.30 | 0.28 |
| | 107.70 | 100.00 |

Green

| | | |
|---|---|---|
| Sancure 20025F | 100.00 | 94.38 |
| Color - Milliken Green Concentrated Ink (90 drops) | 3.15 | 2.97 |
| Color - Milliken Yellow Concentrated Ink (30 drops) | 1.10 | 1.04 |
| Carbopol EP-1 | 1.30 | 1.23 |
| 0.1% Kathon LX 1.5% (3 drops) | 0.10 | 0.09 |
| 0.3% Reputaine B-30 (6 drops) | 0.30 | 0.28 |
| | 105.95 | 100.00 |

Sea Foam Green

| | | |
|---|---|---|
| Sancure 20025F | 100.00 | 98.22 |
| Color - Milliken Green Concentrated Ink (3 drops) | 0.11 | 0.11 |
| Carbopol EP-1 | 1.30 | 1.28 |
| 0.1% Kathon LX 1.5% (3 drops) | 0.10 | 0.10 |
| 0.3% Reputaine B-30 (6 drops) | 0.30 | 0.29 |
| | 101.81 | 100.00 |

Iguana Green

| | | |
|---|---|---|
| Sancure 20025F | 100.00 | 97.11 |
| Color - Milliken Green Concentrated Ink (5 drops) | 0.175 | 0.17 |
| Color - Milliken Yellow Concentrated Ink (30 drops) | 1.10 | 1.07 |
| Carbopol EP-1 | 1.30 | 1.26 |
| 0.1% Kathon LX 1.5% (3 drops) | 0.10 | 0.10 |
| 0.3% Reputaine B-30 (6 drops) | 0.30 | 0.29 |
| | 102.98 | 100.00 |

Wild Orchid

| | | |
|---|---|---|
| Sancure 20025F | 100.00 | 97.46 |
| Color - Milliken Teal Concentrated Ink (1 drop) | 0.035 | 0.03 |
| Color - Milliken Bold Raspberry Concentrated Ink (15 drops) | 0.526 | 0.51 |
| Color - Milliken Bold Primrose Concentrated Ink (10 drops) | 0.35 | 0.34 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| | 102.61 | 100.00 |

Tropical Violet

| | | |
|---|---|---|
| Sancure 20025F | 100.00 | 97.99 |
| Color - Milliken Violet Concentrated Ink (10 drops) | 0.35 | 0.34 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| | 102.05 | 100.00 |

Hot Pink

| | | |
|---|---|---|
| Sancure 20025F | 100.00 | 98.02 |
| Color - Milliken Bold Primrose Concentrated Ink (1 drop) | 0.035 | 0.03 |
| Color - Milliken Sandy Tan Concentrated Ink (3 drops) | 0.11 | 0.11 |
| Color - Milliken Bold Raspberry Concentrated Ink (2 drops) | 0.07 | 0.07 |
| Color - Milliken Bold Red Concentrated Ink (3 drops) | 0.11 | 0.11 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| | 102.03 | 100.00 |

Red

| | | |
|---|---|---|
| Sancure 20025F | 100.00 | 96.34 |
| Color - Milliken Bold Red Concentrated Ink (60 drops) | 2.10 | 2.02 |
| Carbopol EP-1 | 1.30 | 1.25 |
| 0.1% Kathon LX 1.5% (3 drops) | 0.10 | 0.10 |
| 0.3% Reputaine B-30 (6 drops) | 0.30 | 0.29 |
| | 103.80 | 100.00 |

Desert Flower

| | | |
|---|---|---|
| Sancure 20025F | 100.00 | 96.34 |
| Color - Milliken Bold Primrose Concentrated Ink (60 drops) | 2.10 | 2.02 |
| Carbopol EP-1 | 1.30 | 1.25 |
| 0.1% Kathon LX 1.5% (3 drops) | 0.10 | 0.10 |
| 0.3% Reputaine B-30 (6 drops) | 0.30 | 0.29 |
| | 103.80 | 100.00 |

Orange

| | | |
|---|---|---|
| Sancure 20025F | 100.00 | 96.99 |
| Color - Milliken Orange Concentrated Ink (60 drops) | 1.40 | 1.36 |
| Carbopol EP-1 | 1.30 | 1.26 |
| 0.1% Kathon LX 1.5% (3 drops) | 0.10 | 0.10 |
| 0.3% Reputaine B-30 (6 drops) | 0.30 | 0.29 |
| | 103.10 | 100.00 |

Bittersweet

| | | |
|---|---|---|
| Sancure 20025F | 100.00 | 97.52 |
| Color - Milliken Orange Concentrated Ink (20 drops) | 0.70 | 0.68 |
| Color - Milliken Red Concentrated Ink (4 drops) | 0.14 | 0.14 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| | 102.54 | 100.00 |

Yellow

| | | |
|---|---|---|
| Sancure 20025F | 100.00 | 97.28 |
| Color - Milliken Yelllow Concentrated Ink (30 drops) | 1.10 | 1.07 |
| Carbopol EP-1 | 1.30 | 1.26 |
| 0.1% Kathon LX 1.5% (3 drops) | 0.10 | 0.10 |
| 0.3% Reputaine B-30 (6 drops) | 0.30 | 0.29 |
| | 102.80 | 100.00 |

Brown

| | | |
|---|---|---|
| Sancure 20025F | 100.00 | 96.67 |
| Color - Milliken Brown Concentrated Ink (30 drops) | 1.75 | 1.69 |
| Carbopol EP-1 | 1.30 | 1.26 |
| 0.1% Kathon LX 1.5% (6 drops) | 0.10 | 0.10 |
| 0.3% Reputaine B-30 (3 drops) | 0.30 | 0.29 |
| | 103.45 | 100.00 |

Black

| | | |
|---|---|---|
| Sancure 20025F | 100.00 | 95.06 |
| Color - Milliken Black Concentrated Ink (100 drops) | 3.50 | 3.33 |
| Carbopol EP-1 | 1.30 | 1.24 |
| 0.1% Kathon LX 1.5% (3 drops) | 0.10 | 0.10 |
| 0.3% Reputaine B-30 (6 drops) | 0.30 | 0.29 |
| | 105.20 | 100.00 |

Dolphin Gray

| | | |
|---|---|---|
| Sancure 20025F | 100.00 | 97.66 |
| Color - Milliken Dolphin Gray Concentrated Ink (20 drops) | 0.70 | 0.68 |
| Carbopol EP-1 | 1.30 | 1.27 |
| 0.1% Kathon LX 1.5% (3 drops) | 0.10 | 0.10 |
| 0.3% Reputaine B-30 (6 drops) | 0.30 | 0.29 |
| | 102.40 | 100.00 |

White

| | | |
|---|---|---|
| Sancure 20025F | 100.00 | 98.33 |
| Carbopol EP-1 | 1.30 | 1.28 |
| 0.1% Kathon LX 1.5% (3 drops) | 0.10 | 0.10 |
| 0.3% Reputaine B-30 (6 drops) | 0.30 | 0.29 |
| | 101.70 | 100.00 |

Sparkle Green

| | | |
|---|---|---|
| Sancure 20025F | 100.00 | 91.95 |
| Color - Milliken Ink Concentrate Green (3 drops) | 1.05 | 0.97 |
| Color - EMD Chemicals Inc. Iriodin 163 Shimmer Pearl | 6.00 | 5.52 |
| Carbopol EP-1 | 1.30 | 1.20 |
| 0.1% Kathon LX 1.5% (3 drops) | 0.10 | 0.09 |
| 0.3% Reputaine B-30 (6 drops) | 0.30 | 0.28 |
| | 108.75 | 100.00 |

Sparkle Blue

| | | |
|---|---|---|
| Sancure 20025F | 100.00 | 91.95 |
| Color - Milliken Ink Concentrate Blue (3 drops) | 1.05 | 0.97 |
| Color - EMD Chemicals Inc. Iriodin 163 Shimmer Pearl | 6.00 | 5.52 |
| Carbopol EP-1 | 1.30 | 1.20 |
| 0.1% Kathon LX 1.5% (3 drops) | 0.10 | 0.09 |
| 0.3% Reputaine B-30 (6 drops) | 0.30 | 0.28 |
| | 108.75 | 100.00 |

Card Silver

| | | |
|---|---|---|
| Sancure 20025F | 100.00 | 92.85 |
| Color - Engelhard Mearlin Card Silver BN001 | 6.00 | 5.57 |
| Carbopol EP-1 | 1.30 | 1.21 |
| 0.1% Kathon LX 1.5% (3 drops) | 0.10 | 0.09 |
| 0.3% Reputaine B-30 (6 drops) | 0.30 | 0.28 |
| | 107.70 | 100.00 |

Star Gold

| | | |
|---|---|---|
| Sancure 20025F | 100.00 | 92.85 |
| Color - EMD Chemicals Inc. Iriodin 307 Star Gold Pigment | 6.00 | 5.57 |
| Carbopol EP-1 | 1.30 | 1.21 |
| 0.1% Kathon LX 1.5% (3 drops) | 0.10 | 0.09 |
| 0.3% Reputaine B-30 (6 drops) | 0.30 | 0.28 |
| | 107.70 | 100.00 |

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A three-dimensional paint composition comprising:
a urethane dispersion; and
a thickener,
wherein said urethane dispersion and said thickener are present in effective amounts to allow said paint composition to retain three-dimensional stability,
wherein said composition is phthalate-free.

2. The three-dimensional paint composition of claim 1 wherein said urethane dispersion is water-based.

3. The three-dimensional paint composition of claim 1 wherein said urethane dispersion comprises 0% to 15% by weight acrylic and 85% to 100% by weight urethane.

4. The three-dimensional paint composition of claim 1 wherein said urethane dispersion comprises about 15% by weight acrylic and about 85% by weight urethane.

5. The three-dimensional paint composition of claim 1 wherein said thickener is present in an amount of 1% to 4% by weight of the composition.

6. The three-dimensional paint composition of claim 1 wherein said thickener is present in an amount of about 2.5% by weight of the composition.

7. The three-dimensional paint composition of claim 1 wherein said thickener comprises a high molecular weight homo- and co-polymer of acrylic acid cross-linked with a polyalkenyl polyether.

8. The three-dimensional paint composition of claim 1 further comprising at least one coloring agent.

9. The three-dimensional paint composition of claim 1 further comprising at least one preservative.

10. The three-dimensional paint composition of claim 1 further comprising at least one biocide.

11. The three-dimensional paint composition of claim 1 wherein said composition has a viscosity of in a range of about 7,000 cps to about 125,000 cps.

12. A system for applying three-dimensional paint comprising:
a three-dimensional paint composition comprising a urethane dispersion and a thickener; and
a dispenser or applicator for applying said three-dimensional paint composition,
wherein said urethane dispersion and said thickener are present in effective amounts to allow said paint composition to retain three-dimensional stability,
wherein said composition is phthalate-free.

13. A method for making a three-dimensional paint composition comprising:
combining a urethane dispersion and a thickener to form a mixture,
wherein said mixture retains its three-dimensional stability upon curing,
wherein said composition is phthalate-free.

14. The method of claim 13 further comprising adding a coloring agent to the mixture.

15. The method of claim 13 further comprising adding a preservative to the mixture.

16. The method of claim 13 further comprising adding a biocide to the mixture.

17. The method of claim 13 wherein the thickener comprises a high molecular weight homo- and co-polymer of acrylic acid cross-linked with a polyalkenyl polyether.

18. A toy product comprising:
a three dimensional paint composition comprising a urethane dispersion and a thickener; and
a dispenser or applicator for applying said three-dimensional paint composition,
wherein said urethane dispersion and said thickener are present in effective amounts to allow said paint composition to retain three-dimensional stability,
wherein said composition is phthalate-free.
